(19) United States
(12) Patent Application Publication
(10) Pub. No.: US 2024/0241789 A1
(43) Pub. Date: Jul. 18, 2024

(54) REDUCED ERROR CODE CORRECTION POWER FOR MLC CODEWORDS

(71) Applicant: Micron Technology, Inc., Boise, ID (US)

(72) Inventors: Christophe Vincent Antoine Laurent, Agrate Brianza (MB) (IT); Riccardo Muzzetto, Arcore (MB (IT)

(21) Appl. No.: 18/404,043

(22) Filed: Jan. 4, 2024

Related U.S. Application Data
(60) Provisional application No. 63/479,655, filed on Jan. 12, 2023.

(51) Int. Cl. G06F 11/10; G06F 11/07

(52) U.S. Cl. CPC G06F 11/1068; G06F 11/076; G06F 11/1012

(57) ABSTRACT

In some aspects, the techniques described herein relate to a method including: selecting a plurality of coding tables, the plurality of coding tables including an encoding table and a decoding table; building an error table using the plurality of coding tables, the error table representing potential bit errors that may occur during reading and writing to a memory device using the plurality of coding tables; masking the error table to eliminate error values in the error table meeting a preconfigured condition; determining if the error table includes one or more errors in invalid positions; and storing the error table when the error table does not include one or more errors in invalid positions.

### RELATED APPLICATIONS

The present application claims priority to Prov. U.S. Pat. App. Ser. No. 63/479,655 filed Jan. 12, 2023, the entire disclosure of which application is hereby incorporated herein by reference.

### TECHNICAL FIELD

At least some embodiments disclosed herein relate to memory systems in general and, more particularly but not limited to, techniques of configuring memory cells to store data.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

A memory device can include a memory integrated circuit having one or more arrays of memory cells formed on an integrated circuit die of semiconducting material. A memory cell is the smallest unit of memory that can be individually used or operated upon to store data. In general, a memory cell can store one or more bits of data.

Different types of memory cells have been developed for memory integrated circuits, such as random access memory (RAM), read-only memory (ROM), dynamic random access memory (DRAM), static random access memory (SRAM), synchronous dynamic random access memory (SDRAM), phase change memory (PCM), magneto random access memory (MRAM), negative-or (NOR) flash memory, electrically erasable programmable read-only memory (EEPROM), flash memory, etc.

Some integrated circuit memory cells are volatile and require power to maintain data stored in the cells. Examples of volatile memory include Dynamic Random-Access Memory (DRAM) and Static Random-Access Memory (SRAM).

Some integrated circuit memory cells are non-volatile and can retain stored data even when not powered. Examples of non-volatile memory include flash memory, Read-Only Memory (ROM), Programmable Read-Only Memory (PROM), Erasable Programmable Read-Only Memory (EPROM) and Electronically Erasable Programmable Read-Only Memory (EEPROM) memory, etc. Flash memory includes negative-and (NAND) type flash memory or a negative-or (NOR) type flash memory. A NAND memory cell is based on a NAND logic gate; and a NOR memory cell is based on a NOR logic gate.

Cross-point memory (e.g., 3D XPoint memory) uses an array of non-volatile memory cells. The memory cells in cross-point memory are transistor-less. Each of such memory cells can have a selector device and optionally a phase-change memory device that are stacked together as a column in an integrated circuit. Memory cells of such columns are connected in the integrated circuit via two layers of wires running in directions that are perpendicular to each other. One of the two layers is above the memory cells; and the other layer is below the memory cells. Thus, each memory cell can be individually selected at a cross point of two wires running in different directions in two layers. Cross point memory devices are fast and non-volatile and can be used as a unified memory pool for processing and storage.

A non-volatile integrated circuit memory cell can be programmed to store data by applying a voltage or a pattern of voltage to the memory cell during a program/write operation. The program/write operation sets the memory cell in a state that corresponds to the data being programmed/stored into the memory cell. The data stored in the memory cell can be retrieved in a read operation by examining the state of the memory cell. The read operation determines the state of the memory cell by applying a voltage and determining whether the memory cell becomes conductive at a voltage corresponding to a pre-defined state.

### BRIEF DESCRIPTION OF THE DRAWINGS

The embodiments are illustrated by way of example and not limitation in the figures of the accompanying drawings in which like references indicate similar elements.

FIG. 1 shows a memory device configured with a programming manager according to one embodiment.

FIG. 2 shows a memory cell with a bitline driver and a wordline driver configured to apply voltage pulses according to one embodiment.

FIG. 3 illustrates distributions of threshold voltages of memory cells each configured to represent one of three predetermined values according to one embodiment.

FIGS. 4 to 6 illustrate voltage pulses applied to configure memory cells to store data according to some embodiments.

FIG. 7 illustrates dividing a codeword into two sub-codewords.

FIG. 8 is a diagram illustrating an error table associated with a randomly chosen coding table.

FIG. 9 is a diagram illustrating an error table generating using the disclosed embodiments.

FIG. 10 is a flow diagram illustrating a method for building a coding table according to some of the disclosed embodiments.

FIG. 11 is a flow diagram illustrating a method for correcting errors in a ternary cell codeword according to some of the disclosed embodiments.

FIG. 12 is a flow diagram illustrating a method for correcting errors in a ternary cell codeword according to some of the disclosed embodiments.

FIG. 13 illustrates an example computing system having a memory sub-system in accordance with some embodiments of the present disclosure.

FIG. 14 is a block diagram of an example computer system in which embodiments of the present disclosure can operate.

### DETAILED DESCRIPTION

At least some aspects of the disclosure are directed to a memory sub-system configured to correct errors when reading one or more self-selecting memory cells.

The memory sub-system can be used as a storage device and/or a memory module. Examples of storage devices, memory modules, and memory devices are described below in conjunction with the following figures. A host system can utilize a memory sub-system that includes one or more components, such as memory devices that store data. The host system can provide data to be stored at the memory sub-system and can request data to be retrieved from the memory sub-system.

An integrated circuit memory cell, such as a memory cell in a flash memory or a memory cell in a cross-point memory, can be programmed to store data by the way of its state at a voltage applied across the memory cell. For example, if a memory cell is configured or programmed in such a state that allows a substantial current to pass the memory cell at a voltage in a predefined voltage region, the memory cell is considered to have been configured or programmed to store a first bit value (e.g., one or zero); and otherwise, the memory cell is storing a second bit value (e.g., zero or one). Optionally, a memory cell can be configured or programmed to store more than one bit of data by being configured or programmed to have a threshold voltage in one of more than two separate voltage regions.

The threshold voltage of a memory cell is such that when the magnitude of the voltage applied across the memory cell is increased to above the threshold voltage, the memory cell changes rapidly or abruptly, snaps, or jumps from a non-conductive state to a conductive state. The non-conductive state allows a small leak current to go through the memory cell; and in contrast, the conductive state allows more than a threshold amount of current to go through. Thus, a memory device can use a sensor to detect the change or determine the conductive/non-conductive state of the memory device at one or more applied voltages, to evaluate or classify the level of the threshold voltage of the memory cell and thus its stored data.

The threshold voltage of a memory cell being configured or programmed to be in different voltage regions can be used to represent different data values stored in the memory cell. For example, the threshold voltage of the memory cell can be programmed to be in any of four predefined voltage regions; and each of the regions can be used to represent the bit values of a different two-bit data item. Thus, when given a two-bit data item, one of the four voltage regions can be selected based on a mapping between two-bit data items and voltage regions; and the threshold voltage of the memory cell can be adjusted, programmed, or configured to be in the selected voltage region to represent or store the given two-bit data item. To retrieve, determine, or read the data item from the memory cell, one or more read voltages can be applied across the memory cell to determine which of the four voltage regions contain the threshold voltage of the memory cell. The identification of the voltage region that contains the threshold voltage of the memory cell provides the two-bit data item that has been stored, programmed, or written into the memory cell.

For example, a memory cell can be configured or programmed to store a one-bit data item in a Single Level Cell (SLC) mode, or a two-bit data item in a Multi-Level Cell (MLC) mode, or a three-bit data item in a Triple Level Cell (TLC) mode, or a four-bit data item in Quad-Level Cell (QLC) mode, or a five-bit data item in a Penta-Level Cell (PLC) mode.

The threshold voltage of a memory cell can change or drift over a period of time, usage, and/or read operations, and in response to certain environmental factors, such as temperate changes. The rate of change or drift can increase as the memory cell ages. The change or drift can result in errors in determining, retrieving, or reading the data item back from the memory cell.

Random errors in reading memory cells can be detected and corrected using redundant information. Data to be stored into memory cells can be encoded to include redundant information to facilitate error detection and recovery. When data encoded with redundant information is stored in a memory sub-system, the memory sub-system can detect errors in data represented by the voltage regions of the threshold voltages of the memory cells and/or recover the original data that is used to generate the data used to program the threshold voltages of the memory cells. The recovery operation can be successful (or have a high probability of success) when the data represented by the threshold voltages of the memory cells and thus retrieved directly from the memory cells in the memory sub-system contains fewer errors, or the bit error rate in the retrieved data is low and/or when the amount of redundant information is high. For example, error detection and data recovery can be performed using techniques such as Error Correction Code (ECC), Low-Density Parity-Check (LDPC) code, etc., as will be discussed in more detail herein.

It is a challenge to efficiently program a memory cell into an intermediate state representing by its threshold voltage being in a voltage region assigned to represent a value, separate from a high voltage region and a low voltage region. It is relatively easy to program the threshold voltage of a memory cell into the high voltage region and the low voltage region. It is difficult to precisely program the threshold voltage of the memory cell into an intermediate region between, but having no overlapping with, the high voltage region and the low voltage region.

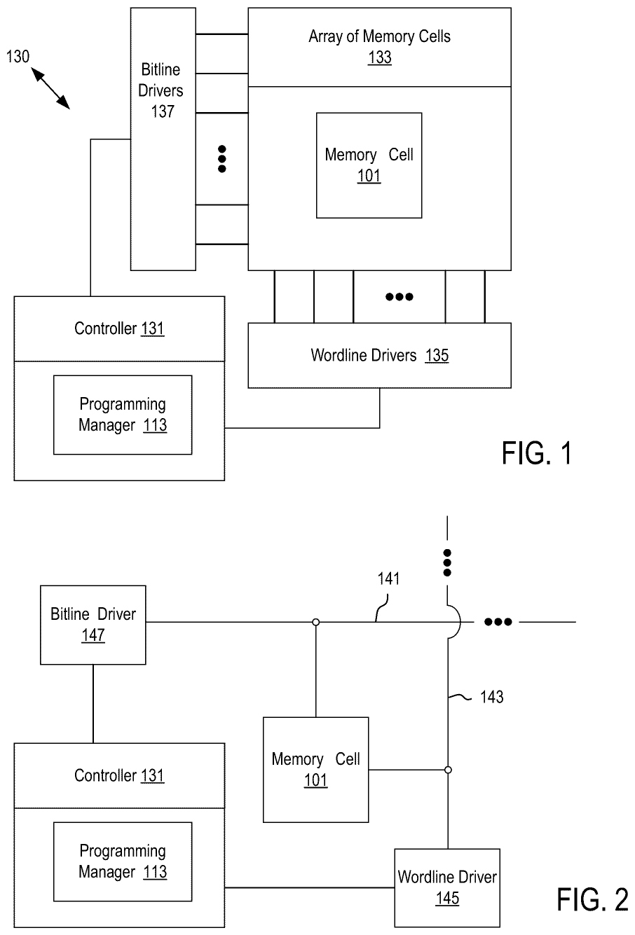

FIG. 1 shows a memory device 130 configured with a programming manager 113 according to one embodiment.

In FIG. 1, the memory device 130 includes an array 133 of memory cells, such as a memory cell 101. An array 133 can be referred to as a tile; and a memory device (e.g., 130) can have one or more tiles. Different tiles can be operated in parallel in a memory device (e.g., 130).

For example, the memory device 130 illustrated in FIG. 1 can have a cross-point memory having at least the array 133 of memory cells (e.g., 101).

In some implementations, the cross point memory uses a memory cell 101 that has an element (e.g., a sole element) acting both as a selector device and a memory device. For example, the memory cell 101 can use a single piece of alloy with variable threshold capability. The read/write operations of such a memory cell 101 can be based on thresholding the memory cell 101 while inhibiting other cells in sub-threshold bias, in a way similar to the read/write operations for a memory cell having a first element acting as a selector device and a second element acting as a phase-change memory device that are stacked together as a column. A selector device usable to store information can be referred to as a selector/memory device.

The memory device 130 of FIG. 1 includes a controller 131 that operates bitline drivers 137 and wordline drivers 135 to access the individual memory cells (e.g., 101) in the array 133.

For example, each memory cell (e.g., 101) in the array 133 can be accessed via voltages driven by a pair of a bitline driver 147 and a wordline driver 145, as illustrated in FIG. 2.

The controller 131 includes a programming manager 113 configured to implement a counter-controlled programming pulse. The programming manager 113 can be implemented, for example, via logic circuits and/or microcodes/instructions. For example, to program the threshold voltage of the memory cell 101 into a second voltage region adjacent to a first voltage region, the programming manager 113 can instruct the bitline drivers 137 and the wordline drivers 135 to initially apply a voltage pulse configured to program the threshold voltage of the memory cell 101 into the first voltage region. After the completion of the initial voltage pulse, the programming manager 113 further instructs the bitline drivers 137 and the wordline drivers 135 to apply a subsequent voltage pulse to move the threshold voltage of the memory cell 101 from the first voltage region to the adjacent second voltage region that is separate from the first voltage region. The magnitude of the subsequent voltage pulse is dynamically controlled for a set of memory cells that are to be read together for a data item (e.g., a codeword for error detection and data recovery using an Error Correction Code (ECC)). The programming manager 113 can instruct the bitline drivers 137 and the wordline drivers 135 to increase the applied magnitude in increments until each and every of the memory cells to be programmed to the second voltage regions are conductive under the applied magnitude. For example, a counter can be used to count the number of memory cells that are in a conductive state under the current increment of the magnitude. When the magnitude is increased to a level of increment that causes the value in the counter to be equal to the number of memory cells in the codeword to be programmed to the adjacent second voltage region, no further increment is applied to the magnitude of the subsequent voltage pulse applied to the memory cells.

FIG. 2 shows a memory cell 101 with a bitline driver 147 and a wordline driver 145 configured to apply voltage pulses according to one embodiment. For example, the memory cell 101 can be a typical memory cell 101 in the memory cell array 133 of FIG. 1.

The bitline driver 147 and the wordline driver 145 of FIG. 2 are controlled by the programming manager 113 of the controller 131 to selectively apply one or more voltages pulses to the memory cell 101.

The bitline driver 147 and the wordline driver 145 can apply voltages of different polarities on the memory cell 101.

For example, in applying one polarity of voltage (e.g., positive polarity), the bitline driver 147 drives a positive voltage relative to the ground on a bitline 141 connected to a row of memory cells in the array 133; and the wordline driver 145 drives a negative voltage relative to the ground on a wordline 143 connected to a column of memory cells in the array 133.

In applying the opposite polarity of voltage (e.g., negative polarity), the bitline driver 147 drives a negative voltage on the bitline 141; and the wordline driver 145 drives a positive voltage on the wordline 143.

The memory cell 101 is in both the row connected to the bitline 141 and the column connected to the wordline 143. Thus, the memory cell 101 is subjected to the voltage difference between the voltage driven by the bitline driver 147 on the bitline 141 and the voltage driven by the wordline driver 145 on the wordline 143.

In general, when the voltage driven by the bitline driver 147 is higher than the voltage driven by the wordline driver 145, the memory cell 101 is subjected to a voltage in one polarity (e.g., positive polarity); and when the voltage driven by the bitline driver 147 is lower than the voltage driven by the wordline driver 145, the memory cell 101 is subjected to a voltage in the opposite polarity (e.g., negative polarity).

In some implementations, the memory cell 101 is a self-selecting memory cell implemented using a selector/memory device. The selector/memory device has a chalcogenide (e.g., chalcogenide material and/or chalcogenide alloy). For example, the chalcogenide material can include a chalcogenide glass such as, for example, an alloy of selenium (Se), tellurium (Te), arsenic (As), antimony (Sb), carbon (C), germanium (Ge), and silicon (Si). A chalcogenide material can primarily have selenium (Se), arsenic (As), and germanium (Ge) and be referred to as SAG-alloy. SAG-alloy can include silicon (Si) and be referred to as SiSAG-alloy. In some embodiments, the chalcogenide glass can include additional elements such as hydrogen (H), oxygen (O), nitrogen (N), chlorine (CI), or fluorine (F), each in atomic or molecular forms. The selector/memory device has a top side and a bottom side. A top electrode is formed on the top side of the selector/memory device for connecting to a bitline 141; and a bottom electrode is formed on the bottom side of the selector/memory device for connecting to a wordline 143. For example, the top and bottom electrodes can be formed of a carbon material. For example, a chalcogenide material of the memory cell 101 can take the form of a crystalline atomic configuration or an amorphous atomic configuration. The threshold voltage of the memory cell 101 can be dependent on the ratio of the material in the crystalline configuration and the material of the amorphous configuration in the memory cell 101. The ratio can change under various conditions (e.g., having currents of different magnitudes and directions going through the memory cell 101).

A self-selecting memory cell 101, having a selector/memory device, can be programmed to have a threshold voltage window. The threshold voltage window can be created by applying programming pulses with opposite polarity to the selector/memory device. For example, the memory cell 101 can be biased to have a positive voltage difference between two sides of the selector/memory device and alternatively, or to have a negative voltage difference between the same two sides of the selector/memory device. When the positive voltage difference is considered in positive polarity, the negative voltage difference is considered in negative polarity that is opposite to the positive polarity. Reading can be performed with a given/fixed polarity. When programmed, the memory cell has a low threshold (e.g., lower than the cell that has been reset, or a cell that has been programmed to have a high threshold), such that during a read operation, the read voltage can cause a programmed cell to snap and thus become conductive while a reset cell remains non-conductive.

For example, to program the voltage threshold of the memory cell 101, the bitline driver 147 and the wordline driver 145 can drive a pulse of voltage onto the memory cell 101 in one polarity (e.g., positive polarity) to snap the memory cell 101 such that the memory cell 101 is in a conductive state. While the memory cell 101 is conductive, the bitline driver 147 and the wordline driver 145 continue driving the programming pulse to change the threshold voltage of the memory cell 101 towards a voltage region that represents the data or bit value(s) to be stored in the memory cell 101.

The controller 131 can be configured in an integrated circuit having a plurality of decks of memory cells. Each deck can be sandwiched between a layer of bitlines, a layer of wordlines; and the memory cells in the deck can be arranged in an array 133. A deck can have one or more arrays or tiles. Adjacent decks of memory cells may share a layer of bitlines (e.g., 141) or a layer of wordlines (e.g., 143). Bitlines are arranged to run in parallel in their layer in one direction; and the wordlines are arranged to run in parallel in their layer in another direction orthogonal to the direction of the bitlines. Each of the bitlines is connected to a row of memory cells in the array; and each of the wordlines is connected to a column of memory cells in the array. Bitline drivers 137 are connected to bitlines in the decks; and wordline drivers 135 are connected to wordlines in the decks. Thus, a typical memory cell 101 is connected to a bitline driver 147 and a wordline driver 145.

The threshold voltage of a typical memory cell 101 is configured to be sufficiently high such that when only one of its bitline driver 147 and wordline driver 145 drives a voltage in either polarity while the other voltage driver holds the respective line to the ground, the magnitude of the voltage applied across the memory cell 101 is insufficient to cause the memory cell 101 to become conductive. Thus, addressing the memory cell 101 can be performed via both of its bitline driver 147 and wordline driver 145 driving a voltage in opposite polarity relative to the ground for operating/selecting the memory cell 101. Other memory cells connected to the same wordline driver 145 can be de-selected by their respective bitline drivers holding the respective bitlines to the ground; and other memory cells connected to the same bitline driver can be de-selected by their respective wordline drives holding the respective wordlines to the ground.

A group of memory cells (e.g., 101) connected to a common wordline driver 145 can be selected for parallel operation by their respective bitline drivers (e.g., 147) driving up the magnitude of voltages in one polarity while the wordline driver 145 is also driving up the magnitude of a voltage in the opposite polarity.

At least some examples are disclosed herein in reference to a cross-point memory having self-selecting memory cells. Other types of memory cells and/or memory having similar threshold voltage characteristics can also be used. For example, memory cells each having a selector device and a phase-change memory device and/or flash memory cells can also be used in at least some embodiments.

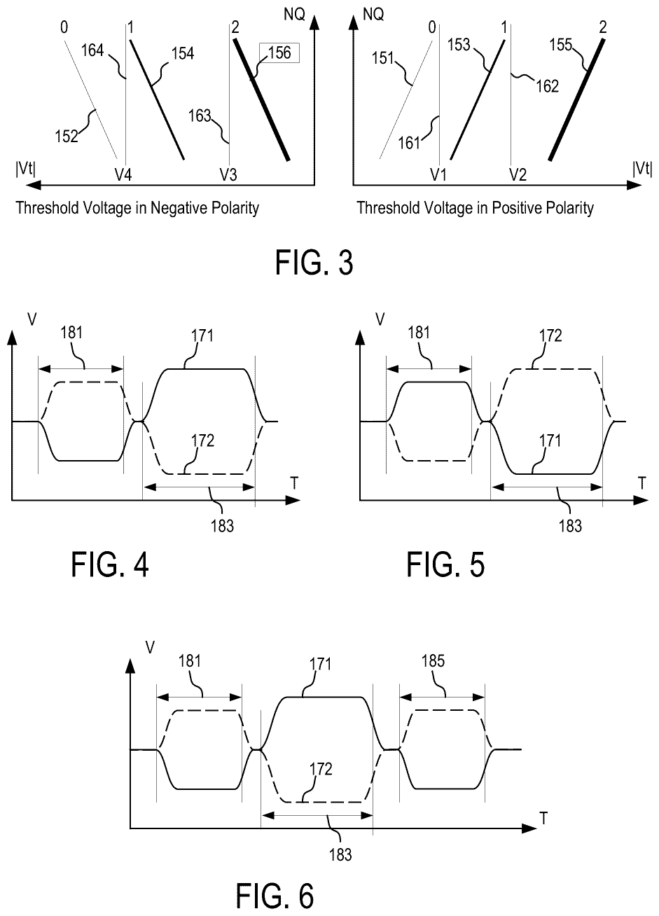

FIG. 3 illustrates distributions of threshold voltages of memory cells each configured to represent one of three predetermined values according to one embodiment. For example, the programming manager 113 of FIGS. 1 and 2 can be used to program the threshold voltage of a memory cell 101 such that the probability distribution of its threshold voltage is as illustrated in FIG. 3.

The probability distribution of the threshold voltage of a memory cell can be illustrated via a normal quantile (NQ) plot, as in FIG. 3. When a probability distribution (e.g., 151) of threshold voltage programmed in a region is a normal distribution (also known as Gaussian distribution), its normal quantile (NQ) plot is seen as aligned on a straight line (e.g., distribution 151).

A self-selecting memory cell (e.g., 101) can have a threshold voltage in negative polarity and a threshold voltage in positive polarity. When a voltage applied on the memory cell 101 in either polarity is increased in magnitude up to its threshold voltage in the corresponding polarity, the memory cell (e.g., 101) snaps from a non-conductive state to a conductive state.

The threshold voltage of a memory cell 101 in negative polarity and the threshold voltage of the memory cell 101 in positive polarity can have different magnitudes. Memory cells programmed to have large magnitudes in threshold voltages in positive polarity can have small magnitudes in threshold voltages in negative polarity; and memory cells programmed to have small magnitudes in threshold voltages in positive polarity can have large magnitudes in threshold voltages in negative polarity.

For example, a memory cell 101 can be programmed to have a small magnitude in threshold voltage according to distribution 151 in the positive polarity to represent a value (e.g., zero); and as a result, its threshold voltage has a large magnitude according to distribution 152 in the negative polarity to represent the same value (e.g., zero). The threshold voltages of the memory cell 101 in the positive and negative polarities can be programmed to the distributions 151 and 152 by applying a voltage pulse in the positive polarity (e.g., as illustrated in FIG. 4) to place the memory cell 101 in a conductive state and to cause a predetermined level of current (e.g., 120 mA) to go through the memory cell 101.

Alternatively, the memory cell 101 can be programmed to have a smaller magnitude in threshold voltage according to distribution 156 in the negative polarity to represent another value (e.g., two); and as a result, its threshold voltage has a large magnitude according to distribution 155 in the positive polarity to represent the same value (e.g., two). The threshold voltages of the memory cell 101 in the positive and negative polarities can be programmed to the distributions 155 and 156 by applying a voltage pulse in the negative polarity (e.g., as illustrated in FIG. 5) to place the memory cell 101 in a conductive state and to cause a predetermined level of current (e.g., 120 mA) to go through the memory cell 101.

The state of having threshold voltages in the distributions 151 and 152 and the state of having threshold voltages in the distributions 155 and 156 are relatively easy to obtain. The programming of the memory cell 101 to such two states can be implemented using voltage pulses illustrated in FIGS. 4 and 5. The voltage regions of the distributions 151, 152, 155 and 156 are controlled primarily by the polarity of the programming voltage pulses and the level of current passing through the memory cell 101 near the end of the programming voltage pulses.

To facilitate the storing of more than one bit of data per memory cell, the memory cell 101 can be programmed into an intermediate state between the two states.

For example, the memory cell 101 can be programmed to have a medium magnitude in threshold voltage according to distribution 153 in the positive polarity to represent a further value (e.g., one); and as a result, its threshold voltage has a magnitude according to distribution 154 in the negative polarity to represent the same value (e.g., one). The threshold voltages of the memory cell 101 in the positive and negative polarities can be programmed to the distributions 153 and 154 by applying a voltage pulse to move the threshold voltages of the memory from the distributions 151 and 152, or from the distributions 155 and 156.

In some implementations, more than one intermediate state can be programmed in a similar way such that the threshold voltage in the positive polarity is in the voltage region of one of four distributions and the threshold voltage in the negative polarity is in the voltage region of one of four distributions. Such four states can be used to represent a two-bit data item stored in the memory cell 101.

In FIG. 3, the voltage distributions 151, 153 and 155 in the positive polarity are separated by read voltage V1 161 and read voltage V2 162. Thus, whether the threshold voltage of the memory cell 101 in the positive polarity is in the distribution 151 can be determined by testing whether the memory cell 101 is conductive at the read voltage V1 161 in the positive polarity; and whether the threshold voltage of the memory cell 101 in the positive polarity is in the distribution 155 can be determined by testing whether the memory cell 101 is non-conductive at the read voltage V2 162 in the positive polarity. If the threshold voltage of the memory cell 101 in the positive polarity is in neither the distribution 151 nor the distribution 155, it is in the distribution 153 representative of the corresponding value (e.g., one).

Similarly, in FIG. 3, the distributions 152, 154 and 156 in the negative polarity are separated by the read voltage V3 163 and read voltage V4 164. Thus, whether the threshold voltage of the memory cell 101 in the negative polarity is in the distribution 156 can be determined by testing whether the memory cell 101 is conductive at the read voltage V3 163 in the negative polarity; and whether the threshold voltage of the memory cell 101 in the negative polarity is in the distribution 152 can be determined by testing whether the memory cell 101 is non-conductive at the read voltage V4 164 in the negative polarity. If the threshold voltage of the memory cell 101 in the negative polarity is in neither the distribution 152 nor the distribution 156, it is in the distribution 154 representative of the corresponding value (e.g., one).

Thus, the determination of the state and thus the value represented by the state (e.g., region of threshold voltage) can be performed by reading the memory cell 101 in the positive polarity using the read voltages V1 and V2, or reading the memory cell 101 in the negative polarity using the read voltages V3 and V4, or a combination of reading the memory cell 101 in the negative polarity using read voltage V3 and in the positive polarity using read voltage V1.

As discussed above in FIGS. 1 through 3, a given memory cell (referred to herein as a ternary cell) can be in three potential states, referred to as set, reset, and ternary states based on the sensed value of the cell. To store n bits of data using such cells, it may be necessary to have 2ⁿ available states to represent all possible variations of an n-bit data. In some types of memory cells (e.g., cross-point memory), it may be challenging to reliably program the threshold voltage of the memory to many distinct voltage regions to represent the different states (and maintain the threshold voltage). Ideally, each cell can store a piece of data independent of other cells. However, in some cases, it can be difficult to even have three distinct states. Thus, when the storage density is increased, storing 1.5 bits per cell may be the maximum improvement without losing reliability. Thus, in some of the implementations, two cells are read simultaneously and the resulting values are mapped to a binary value.

For example, the following encoding table may be used to determine how to program two ternary cells to encode three bits of information:

TABLE 1

| | Sᵢ | Rᵢ | Tᵢ |
|---|---|---|---|
| Sⱼ | X | 110 | 100 |
| Rⱼ | 101 | 010 | 000 |
| Tⱼ | 111 | 011 | 001 |

In Table 1, two cells (i,j) are programmed to store three bits of data. For example, if the binary value of 110 is desired to be written, the i-th cell will be programmed in a reset state (Rᵢ) while the j-th cell will be programmed in a set state (Sⱼ). As illustrated, one state (SᵢSⱼ) is undefined during programming and thus the state SᵢSⱼ does not correspond to a binary value.

During reads, a corresponding decoding table may be used. Table 2 below illustrates a decoding table corresponding to Table 1.

TABLE 2

| | Sᵢ | Rᵢ | Tᵢ |
|---|---|---|---|
| Sⱼ | 100 | 110 | 100 |
| Rⱼ | 101 | 010 | 000 |
| Tⱼ | 111 | 011 | 001 |

In general, the decoding table mirrors the coding table. However, as illustrated, in some implementations, a value of SᵢSⱼ must be defined in the event of read errors. That is, while preventing the programming of the state SᵢSⱼ can be ensured, it cannot be ensured that reading state SᵢSⱼ can be prevented. As such, a value is used in the decoding table. The specific value used is not entirely limited, however, as will be discussed, some encoding and decoding tables may yield better error correction properties than others.

During decoding, a change in the sensed state of a cell can cause numerous errors in the resulting key word. For example, a cell pair programmed as SᵢRⱼ(101) may be read as TᵢRⱼ(000) resulting in two bit errors. Or, for example, a cell pair programed as RᵢRⱼ(010) may be read as SᵢRⱼ(101), resulting in errors on all bits.

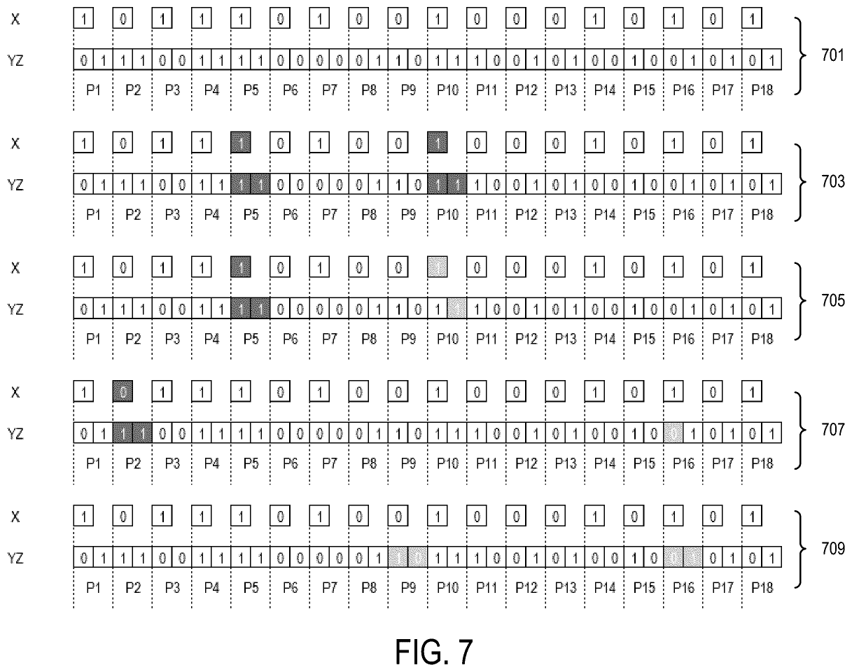

FIG. 7 illustrates dividing a codeword into two sub-codewords.

In an implementation, a given read codeword comprising ternary cells can be divided into two discrete sub-codewords. As illustrated, these codewords are referred to as X and YZ. In an implementation, codeword X is made up of the first read bit of each pair of decoded memory cells, while codeword YZ is made up of the second two bits of each pair of decoded memory cells.

Consider, for example, the bit values “101” and “011” decoded from a first and second pair of ternary cells, respectively. Here, the first bits “1” and “0” are used to generate codeword X (“10”) while the second bits “01” and “11” are used to generate codeword YZ (“0111”). Codewords 701 illustrate a full example of this splitting for ternary cell pairs P1 through P18.

As discussed, during reading zero, one, or two physical ternary cell errors may occur resulting in zero through three bit errors per ternary cell pair. Codewords 703 illustrate a scenario where two cell pairs (P5 and P10) are errantly read, resulting in all bits being incorrect (denoted by darkened bits). As illustrated, this results in four errors in codeword YZ. Codewords 705 illustrate a scenario where one cell pair (P5) results in three bit errors (denoted by darkened bits) while a second cell pair (P10) has two bit errors: one in codeword X and one in codeword YZ (denoted by grayed bits). As a result, codeword YZ in codewords 705 includes three errors.

In codewords 707, one cell pair (P2) includes three bit errors while a second cell pair (P16) includes a bit error in only the y position (similarly, P16 could include only a bit error in the z position). As a result, codeword YZ also includes three bit errors. Finally, in codewords 709, two cell pairs (P9 and P16) include bit errors in both the y and z positions, but no bit error in the x position, resulting in four errors in codeword YZ.

In the following embodiments, systems, the methods and computer-readable media for selecting a coding table to avoid YZ error cases (as in codewords 709) are disclosed. By avoiding bit errors only in the YZ codeword (and not in the X codeword), larger error correction (e.g., ECC4) can be avoided and lower power error correction (e.g., ECC3) can be used. Specifically, the following techniques generate a coding table such that the presence of errors only in the y and z bits is ensured only when all bits of a ternary cell pair are inverted.

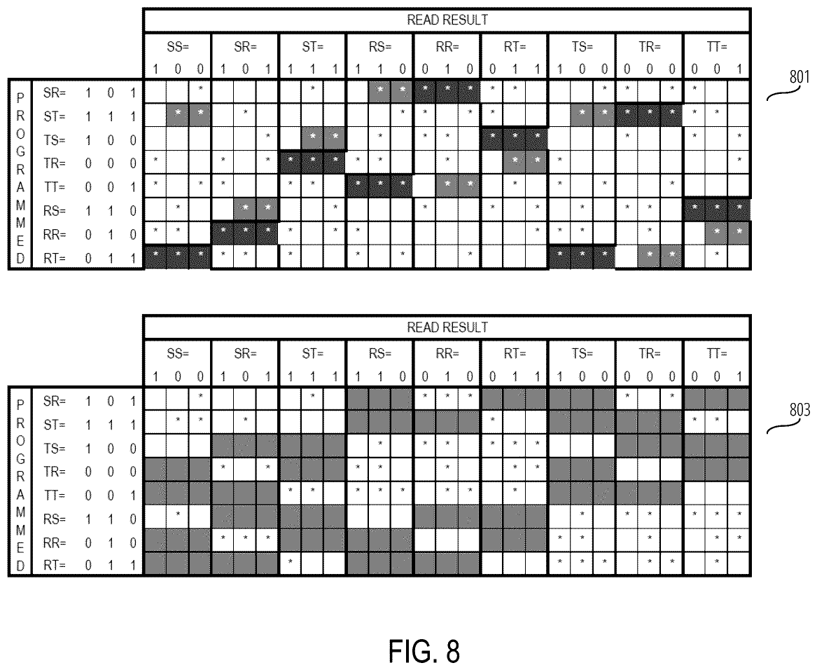

FIG. 8 is a diagram illustrating an error table associated with randomly chosen coding tables.

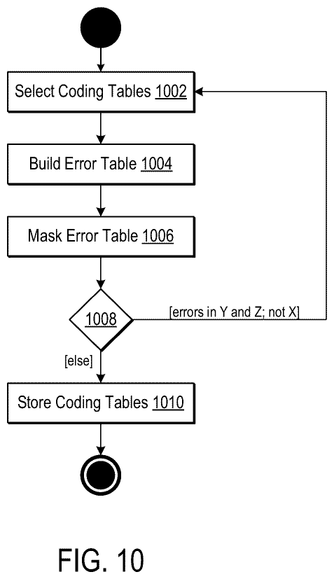

In table 801, an error table containing error values for randomly chosen coding tables is illustrated. As illustrated, the encoding table and decoding tables correspond to those of Tables 1 and 2. In table 801, bit mismatches between read bits and programmed bits are denoted with asterisks. For example, a programmed pair (ST) and read pair (ST) includes no errors while a programmed pair (ST) and read pair (SS) includes two bit errors (111 vs. 100). These mismatches between pair permutations are referred to as error values and, for example, table 801 includes 9×8 (or 72) error values corresponding to the permutations of encoding/decoding pairs. Further, table 801 illustrates a first class of errors denoted in light gray—where errors occur only on the second and third bits (or Y and Z bits)—and a second class of errors denoted in dark gray—where all bits include errors. For example, when programming a cell pair as ST and reading as SS, a first class of error occurs while when programming a cell pair as TR and reading as ST, the second class of error occurs. As will be discussed (especially in connection with FIG. 10), a properly chosen coding table will prevent scenarios where the first class of errors can occur.

Table 803 illustrates a masking table as applied to table 801. Specifically, the masking table includes grayed cells which are placed where two physical cell errors occur. For example, if a cell is programmed as TR and then read as SS, both ternary cell states were improperly read. In some embodiments, situations where both ternary cells include errors can be prevented from occurring physically. Thus, a given memory device employing ternary cells can be ensured that an error occurs only on a single physical cell. Thus, as will be discussed, the masking table of table 803 can be applied to table 801 to determine if any error values remain that include the first class of errors. As can be seen, with randomly chosen coding tables, such first class of errors still occur (e.g., when programming ST and reading SS as illustrated in table 803).

In general, with any chosen coding table, double errors on the YZ codeword and triple errors affecting all bits of a three bit codeword will occur. If two physical errors occur when reading, at most one error will occur on codeword X and at most two errors will occur on codeword YZ. If two pairs of ternary cells include two errors each, at most two errors will appear in codeword X and at most four errors will appear in codeword YZ. Thus, without consideration of a coding table, a two-error ECC is required to correct codeword X and a four-error ECC is require to correct codeword YZ.

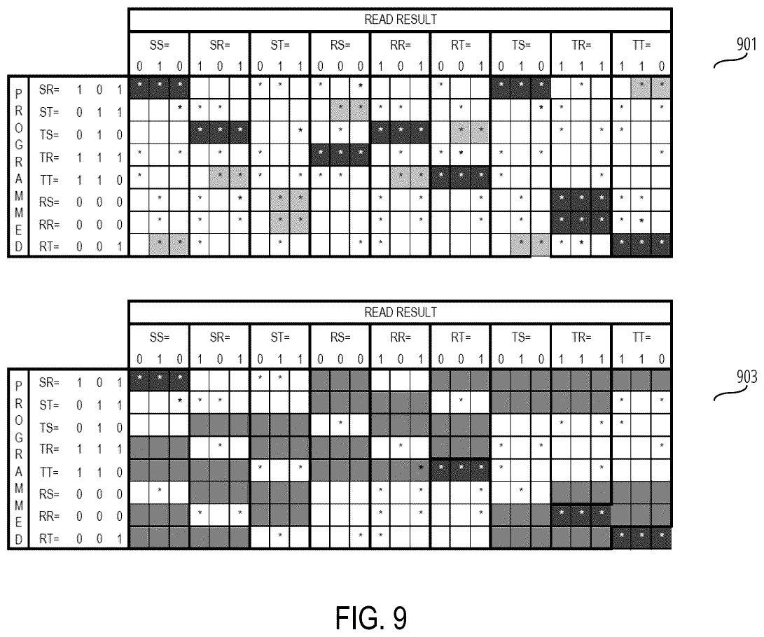

FIG. 9 is a diagram illustrating an error table generated using the disclosed embodiments.

In the illustrated tables, a first table 901 illustrates a set of encoding and decoding values chosen using, for example, the method of FIG. 10. As in FIG. 9, starred cells illustrate bit errors, light gray cells represent the first class of errors (on codeword YZ), and dark gray cells represent the second class of errors (on both X and YZ).

Similarly, second table 903 “masks” all scenarios where two physical cells have errors. In contrast to table 803, second table 903 illustrates that after masking, no combinations appear where two errors appear only in the YZ codeword portion. Thus, if a system were to detect an error in the YZ portion (e.g., when a ternary cell is programmed as SᵢRⱼ but read as SᵢSⱼ), the system can automatically invert all bits of the read word and does not need to perform error correction since it can be guaranteed that if a YZ error occurs, a corresponding X occurs. More concretely, in second table 903, the embodiments can simply invert the binary value 010 (SᵢSⱼ) to obtain the correct codeword 101 (SᵢRⱼ). As will be discussed in FIGS. 10 through 12, this feature of selecting coding tables can be used to reduce the complexity of ECC operations on memory code words based on ternary cells.

FIG. 10 is a flow diagram illustrating a method for building a coding table according to some of the disclosed embodiments.

In step 1002, the method can include selecting coding tables.

In some embodiments, the coding tables can include an encoding table and a decoding table. In some embodiments, an encoding table can include a mapping of binary values to ternary cell states. In some embodiments, a decoding table can include a mapping of ternary cell states to binary values. In some embodiments, the encoding table and decoding table can be randomly chosen.

In step 1004, the method can include building an error table.

In alternative embodiments, an error table can compute all possible errors occurring between encoding (i.e., writing) and decoding (i.e., reading). That is, for a given combination of ternary cells written to a memory device, the error table can include all possible read combination (including both a valid combination and invalid combinations). In some embodiments, the error table can identify cell errors for each permutation. In some embodiments, these cell errors correspond to which bits of a three-bit value are mismatched between the written ternary cells and read ternary cells.

In step 1006, the method can include masking the error table.

As discussed above, masking refers to removing all error cells that satisfy a preconfigured condition. In alternative embodiments, this preconfigured condition can comprise a scenario where both ternary cells include errors. For example, when a cell pair is programmed as SS and read as RR, both cells produce errors. In some embodiments, the masking table is constant and applied regardless of the (potentially randomly) chosen encoding and decoding tables.

In step 1008, the method can include determining if any error values are unmasked that include only errors on the Y and Z portions of the error values.

In one embodiment, each error value is analyzed after masking the error table (i.e., each unmasked error value is inspected). If any of the unmasked error values include errors on both the Y and Z portions but not on the X portion, the method can proceed to step 1002. Specifically, in this scenario, the method determines that the current encoding and decoding tables are invalid and generates new coding tables. In this manner, step 1002 through step 1008 can be continuously re-executed to generate coding tables that satisfy the condition of step 1008.

In step 1010, the method can include storing the coding tables that satisfy the conditions of step 1008. In an embodiment, these coding tables do not produce an error only on the Y and Z positions of a read cell pair when only one error exists in the ternary memory cell. In some embodiments, these coding tables can be stored in a memory device and used during writing and reading to and from a memory device that employs ternary cells, such as that described in FIGS. 1 through 6 above.

As will be discussed next, the above method for generating an encoding and decoding table can be used to reduce ECC requirements of a memory device due to the nature of physical errors of ternary memory cells.

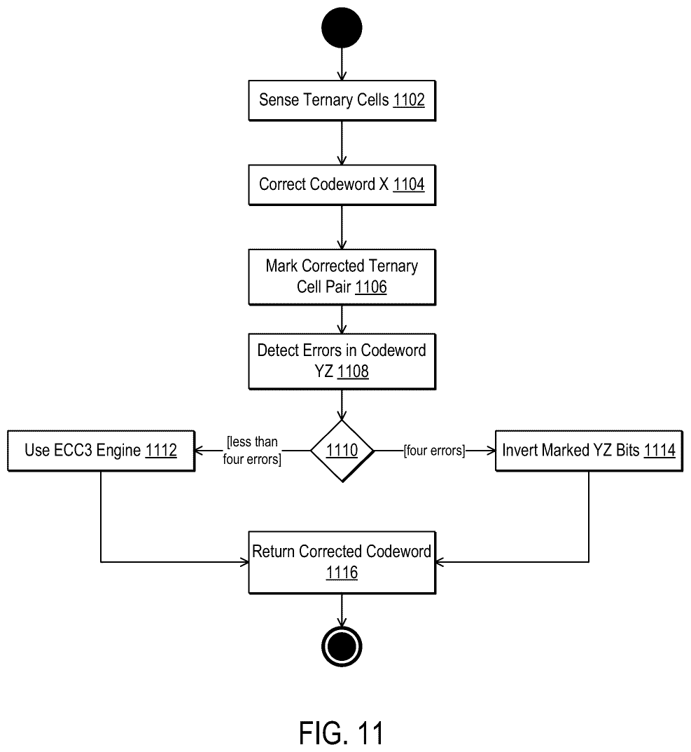

FIG. 11 is a flow diagram illustrating a method for correcting errors in a ternary cell codeword according to some of the disclosed embodiments.

In step 1102, the method can include sensing ternary cells. In some embodiments, these ternary cells can be sensed (or read) as part of reading a codeword from a memory device. In some embodiments, step 1102 can include sensing the ternary states of cells and segmenting the resulting binary mappings (using the decoding table selected using the method of FIG. 10) into two sub-codewords. In one embodiment, the first sub-codeword can be formed by selecting the first bit of a three-bit binary string corresponding to each pair of ternary cells and the second sub-codeword can be formed by selecting the second and third bits of corresponding to each pair of ternary cells. Thus, for example, two pairs of ternary cells may yield 000 and 111 whereby a first sub-codeword (referred to as codeword X) may be “01” and a second sub-codeword (referred to as codeword Y) may be “0011.”

The specific length of the codeword or sub-codewords is not limiting. In some embodiments, however, a given memory device may only be configured to detect and correct two-bit errors in codeword X (referred to as an ECC2 engine).

In step 1104, the method can include correcting codeword X. In some embodiments, if codeword X includes more than two bit errors, the method can fail and issue an error to the device attempting to read from the memory device. However, it is assumed that the first sub-codeword will include two or fewer errors and can thus be corrected using an ECC2 engine. As such, in step 1104, the method can use a first parity portion to correct codeword X using any suitable error correction code. While the description describes the use of an ECC2 engine, the disclosure is not limited as such. For examples, if a given memory is more prone to errors, a stronger ECC (e.g., ECC3, etc.) may be used for codeword X. Accordingly, in such embodiments, the ECC engine for codeword YZ may be proportionately increased to handle the normal error rate of the memory device.

In step 1106, the method can include marking which cell pair included the bit in codeword X that was corrected. In some embodiments, this marking can include an address of the ternary cell pair that can be stored temporarily in volatile memory (e.g., DRAM) for later use, as will be discussed. Alternatively, the address can be stored in a register or other volatile storage location (for example, if the address is required in a short time, e.g., a few nanoseconds). Further, in some implementations, the address need not be stored an instead can be cascaded into the following step 1108.

In step 1108, the method can include detecting the number of errors in the second sub-codeword (codeword YZ). In one embodiment, step 1108 can include using an ECC algorithm to detect how many errors are present in codeword YZ. In some embodiments, an ECC capable of detecting up to four errors can be used. In some implementations, such an EC may be capable of correcting up to two errors. The use of error detection in lieu of correction results in a lower complexity of the ECC used in step 1108. The specific ECC algorithm used is non-limiting. In some embodiments, the ECC algorithm chosen may detect up to four errors to reduce parity requirements of the ECC.

In step 1110, the method can include determining if four errors were detected in codeword YZ. Similar to step 1104, the method may only be capable of detecting four errors in codeword YZ. In some embodiments, an ECC algorithm that can detect four errors and correct three may be used.

If, in step 1110, the method determines that less than four errors appeared in codeword YZ, the method, in step 1112, can correct the errors using an ECC3 engine (e.g., an ECC engine that can correct up to three errors).

If, on the other hand, four errors occur, the method (in step 1114) can simply invert the bit errors. Specifically, the method can load the address of the ternary cells marked in step 1106 and invert the corresponding Y and Z bits of the corrected codeword X bits. Since no ECC algorithm is needed, this operation can be performed without regard to parity bits or time-consuming ECC processing and thus enables (along with step 1114) the use of an ECC3 engine to correct up to four bit errors.

After correcting the codeword YZ in step 1112 or step 1114, the method can return the corrected codeword. In some embodiments, step 1116 can include unsegmenting codeword X and YZ into a single codeword to return to the calling device.

With respect to the method of FIG. 11, it should be noted that the universe of potential correctable errors can be reduced to the chosen coding table. Specifically, when four errors are detected, the choice of coding table can be used to bypass ECC operations and simply invert bits in codeword YZ. This is because the coding tables chosen using the method of FIG. 10 explicitly ensure that any errors on both the Y and Z bits of a binary string co-appear with an error on the corresponding X bit of the same string. That is, the coding tables avoid a scenario where the Y and Z bits of any given decoding include an error while the corresponding X bit is without error.

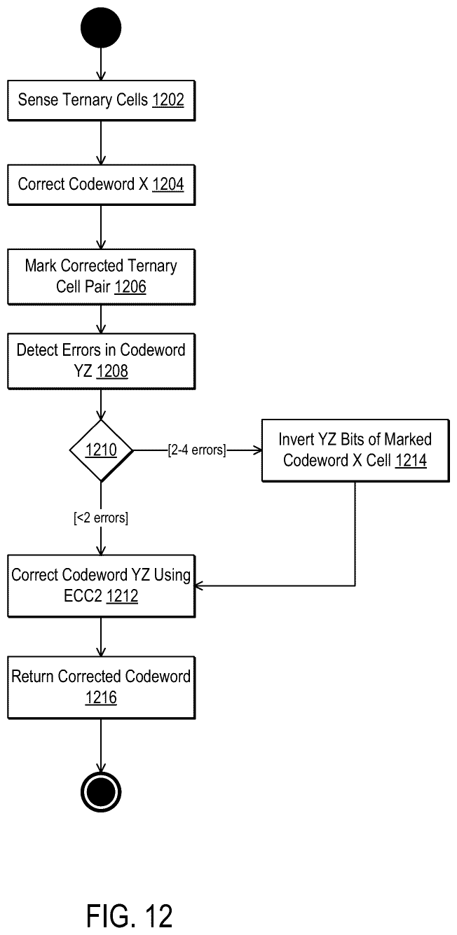

FIG. 12 is a flow diagram illustrating a method for correcting errors in a ternary cell codeword according to some of the disclosed embodiments.

In step 1202, the method can include sensing ternary cells. In some embodiments, these ternary cells can be sensed (or read) as part of reading a codeword from a memory device. In some embodiments, step 1202 can include sensing the ternary states of cells and segmenting the resulting binary mappings (using the decoding table selected using the method of FIG. 10) into two sub-codewords. In one embodiment, the first sub-codeword can be formed by selecting the first bit of a three-bit binary string corresponding to each pair of ternary cells and the second sub-codeword can be formed by selecting the second and third bits of corresponding to each pair of ternary cells. Thus, for example, two pairs of ternary cells may yield 000 and 111 whereby a first sub-codeword (referred to as codeword X) may be “01” and a second sub-codeword (referred to as codeword Y) may be “0011.”

The specific length of the codeword or sub-codewords is not limiting. In some embodiments, however, a given memory device may only be configured to detect and correct two-bit errors in codeword X (referred to as an ECC2 engine). As discussed above, other ECC engines (e.g., ECC3, etc.) may be used based on the observed error rate of a memory device.

In step 1204, the method can include correcting codeword X. In some embodiments, if codeword X includes more than two bit errors, the method can fail and issue an error to the device attempting to read from the memory device. However, it is assumed that the first sub-codeword will include two or fewer errors and can thus be corrected using an ECC2 engine. As such, in step 1204, the method can use a first parity portion to correct codeword X using any suitable error correction code.

In step 1206, the method can include marking which cell pair included the bit in codeword X that was corrected. In some embodiments, this marking can include an address of the ternary cell pair that can be stored temporarily in volatile memory (e.g., DRAM) for later use, as will be discussed. Alternatively, the address can be stored in a register or other volatile storage location (for example, if the address is required in a short time, e.g., a few nanoseconds). Further, in some implementations, the address need not be stored an instead can be cascaded into the following step 1108.

In step 1208, the method can include detecting the number of errors in the second sub-codeword (codeword YZ). In one embodiment, step 1208 can include using an ECC algorithm to detect how many errors are present in codeword YZ. In some embodiments, an ECC capable of correctly counting up to four errors. For example, aBCH-4 code may be used. The specific ECC algorithm used is non-limiting. In some embodiments, the ECC algorithm chosen may detect up to four errors to reduce parity requirements of the ECC. In some implementations, such an EC may be capable of correcting up to two errors. The use of error detection in lieu of correction results in a lower complexity of the ECC used in step 1108.

In step 1210, the method can include determining how many errors occur in codeword YZ. As discussed, the ECC algorithm may be capable of correctly calculating up to four errors.

If less than two errors are detected (e.g., zero or only one error was detected), the method may proceed to correct codeword YZ using an ECC2 engine (i.e., an ECC algorithm that can correct up to two errors).

On the other hand, if two or four errors are detected, the method can invert the YZ bits of the ternary cell pairs marked in 1206 in step 1214. Specifically, if four errors are detected, it can be ensured that these two bit errors in codeword YZ correspond to two errors in codeword X corrected in step 1204 and marked in step 1206. In this respect, the method of FIG. 12 operates similar to that of FIG. 11. However, in the method of FIG. 12, if two or three bit errors in codeword are detected, the corresponding YZ bits of all corrected codeword X bits are inverted. In the scenario of two or three bit errors in codeword YZ, this may introduce additional errors. However, based on the chosen coding tables, it can be ensured that this inversion will at most result in two errors in codeword YZ. Thus, the method can execute step 1212 to correct the codeword using an ECC2 engine to address this introduction of errors. If step 1214 does not introduce errors, the ECC2 engine will not correct errors however if it does, step 1214 with correct these errors.

After correcting the codeword YZ in step 1212, the method can return the corrected codeword. In some embodiments, step 1216 can include unsegmenting codeword X and YZ into a single codeword to return to the calling device.

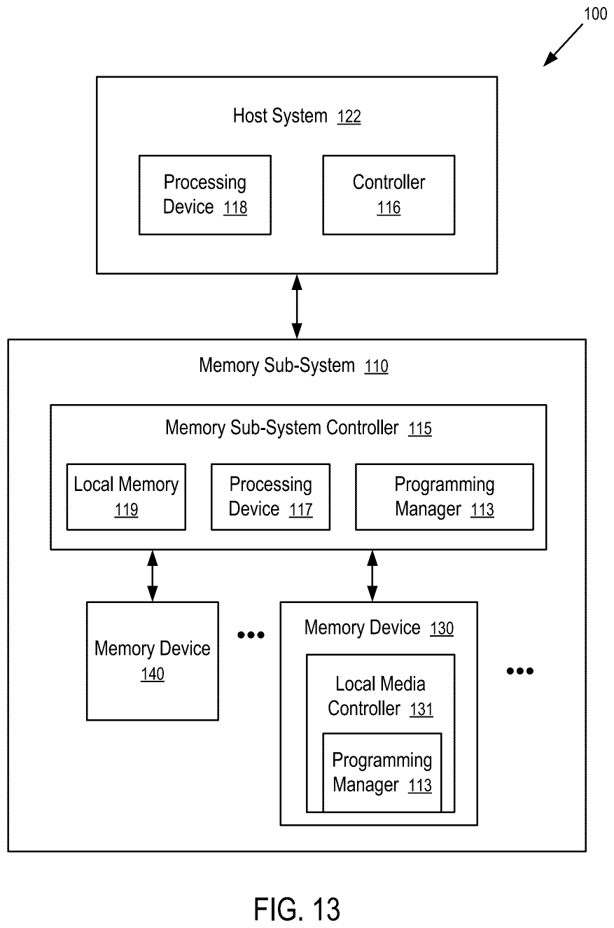

FIG. 13 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130 of FIG. 1), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or such a computing device that includes memory and a processing device.

The computing system 100 can include a host system 122 that is coupled to one or more memory sub-systems 110. FIG. 13 illustrates one example of a host system 122 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 122 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 122 uses the memory sub-system 110, for example, to write data to the memory sub-system 110 and read data from the memory sub-system 110.

The host system 122 can be coupled to the memory sub-system 110 via a physical host interface. Examples of a physical host interface include, but are not limited to, a serial advanced technology attachment (SATA) interface, a peripheral component interconnect express (PCIe) interface, a universal serial bus (USB) interface, a Fibre Channel, a Serial Attached SCSI (SAS) interface, a double data rate (DDR) memory bus interface, a Small Computer System Interface (SCSI), a dual in-line memory module (DIMM) interface (e.g., DIMM socket interface that supports Double Data Rate (DDR)), an Open NAND Flash Interface (ONFI), a Double Data Rate (DDR) interface, a Low Power Double Data Rate (LPDDR) interface, or any other interface. The physical host interface can be used to transmit data between the host system 122 and the memory sub-system 110. The host system 122 can further utilize an NVM Express (NVMe) interface to access components (e.g., memory devices 130 of FIG. 1) when the memory sub-system 110 is coupled with the host system 122 by the PCIe interface. The physical host interface can provide an interface for passing control, address, data, and other signals between the memory sub-system 110 and the host system 122. FIG. 13 illustrates a memory sub-system 110 as an example. In general, the host system 122 can access multiple memory sub-systems via a same communication connection, multiple separate communication connections, and/or a combination of communication connections.

The processing device 118 of the host system 122 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 122 and the memory sub-system 110. In general, the controller 116 can send commands or requests to the memory sub-system 110 for desired access to memory devices 130, 140. The controller 116 can further include interface circuitry to communicate with the memory sub-system 110. The interface circuitry can convert responses received from memory sub-system 110 into information for the host system 122.

The controller 116 of the host system 122 can communicate with controller 115 of the memory sub-system 110 to perform operations such as reading data, writing data, or erasing data at the memory devices 130, 140 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 130, 140 can include any combination of the different types of non-volatile memory components and/or volatile memory components. The volatile memory devices (e.g., memory device 140) can be, but are not limited to, random access memory (RAM), such as dynamic random-access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (e.g., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (e.g., processor) configured to execute instructions stored in a local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 122.

In some embodiments, the local memory 119 can include memory registers storing memory pointers, fetched data, etc. The local memory 119 can also include read-only memory (ROM) for storing micro-code. While the example memory sub-system 110 in FIG. 13 has been illustrated as including the controller 115, in another embodiment of the present disclosure, a memory sub-system 110 does not include a controller 115, and can instead rely upon external control (e.g., provided by an external host, or by a processor or controller separate from the memory sub-system).

In general, the controller 115 can receive commands or operations from the host system 122 and can convert the commands or operations into instructions or appropriate commands to achieve the desired access to the memory devices 130. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The controller 115 can further include host interface circuitry to communicate with the host system 122 via the physical host interface. The host interface circuitry can convert the commands received from the host system into command instructions to access the memory devices 130 as well as convert responses associated with the memory devices 130 into information for the host system 122.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory devices 130.

In some embodiments, the memory devices 130 include local media controllers 131 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 131) for media management within the same memory device package. An example of a managed memory device is a managed NAND (MNAND) device.

The controller 115 and/or a memory device 130 can include a programming manager 113, such as the programming manager 113 discussed above in connection with FIGS. 1 to 6. In some embodiments, the controller 115 in the memory sub-system 110 includes at least a portion of the programming manager 113. In other embodiments, or in combination, the controller 116 and/or the processing device 118 in the host system 122 includes at least a portion of the programming manager 113. For example, the controller 115, the controller 116, and/or the processing device 118 can include logic circuitry implementing the programming manager 113. For example, the controller 115, or the processing device 118 (e.g., processor) of the host system 122, can be configured to execute instructions stored in memory for performing the operations of the programming manager 113 described herein. In some embodiments, the programming manager 113 is implemented in an integrated circuit chip (e.g., memory device 130) installed in the memory sub-system 110. In other embodiments, the programming manager 113 can be part of firmware of the memory sub-system 110, an operating system of the host system 122, a device driver, or an application, or any combination therein.

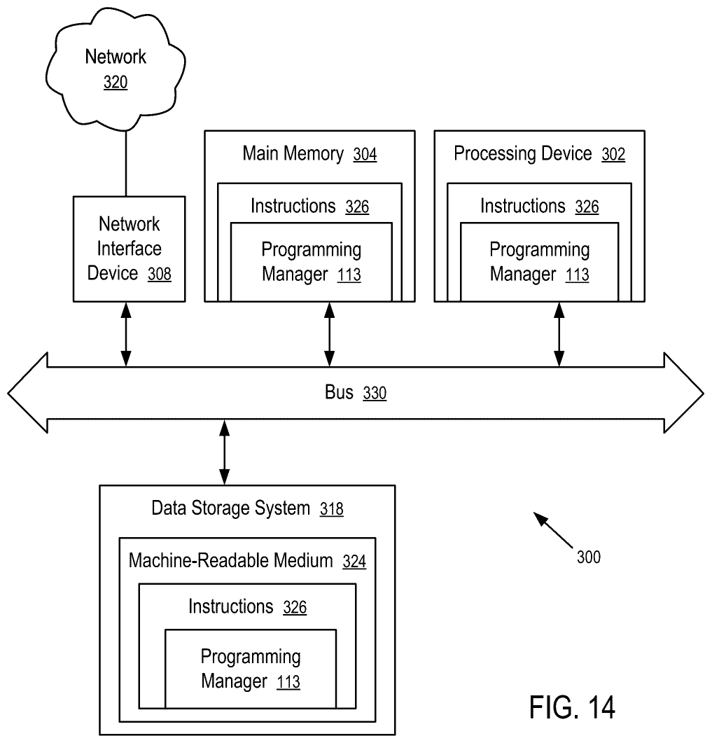

FIG. 14 illustrates an example machine of a computer system 300 within which a set of instructions, for causing the machine to perform any one or more of the methodologies discussed herein, can be executed. In some embodiments, the computer system 300 can correspond to a host system (e.g., the host system 122 of FIG. 13) that includes, is coupled to, or utilizes a memory sub-system (e.g., the memory sub-system 110 of FIG. 13) or can be used to perform the operations of a programming manager 113 (e.g., to execute instructions to perform operations corresponding to the programming manager 113 described with reference to FIGS. 10-12). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 300 includes a processing device 302, a main memory 304 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 318, which communicate with each other via a bus 330 (which can include multiple buses).

Processing device 302 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 302 can also be one or more special-purpose processing devices such as an application specific integrated circuit (ASIC), a field programmable gate array (FPGA), a digital signal processor (DSP), network processor, or the like. The processing device 302 is configured to execute instructions 326 for performing the operations and steps discussed herein. The computer system 300 can further include a network interface device 308 to communicate over the network 320.

The data storage system 318 can include a machine-readable medium 324 (also known as a computer-readable medium) on which is stored one or more sets of instructions 326 or software embodying any one or more of the methodologies or functions described herein. The instructions 326 can also reside, completely or at least partially, within the main memory 304 and/or within the processing device 302 during execution thereof by the computer system 300, the main memory 304 and the processing device 302 also constituting machine-readable storage media. The machine-readable medium 324, data storage system 318, and/or main memory 304 can correspond to the memory sub-system 110 of FIG. 13.

In one embodiment, the instructions 326 include instructions to implement functionality corresponding to a programming manager 113 (e.g., the programming manager 113 described with reference to FIGS. 1-6). While the machine-readable medium 324 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

We claim:

1. A method comprising:
selecting a plurality of coding tables, the plurality of coding tables including an encoding table and a decoding table;
building an error table using the plurality of coding tables, the error table representing potential bit errors that may occur during reading and writing to a memory device using the plurality of coding tables;
masking the error table to eliminate error values in the error table meeting a preconfigured condition;
determining if the error table includes one or more errors in invalid positions; and
storing the error table when the error table does not include one or more errors in invalid positions.

2. The method of claim 1, wherein the encoding table maps a plurality of binary values to write to a plurality of combinations of ternary cell states and wherein the decoding table maps a plurality of read ternary cell pair states to a plurality of binary values.

3. The method of claim 1, wherein the error table includes a plurality of error values, each error value including three bits, each bit in the three bits representing whether an error occurred at the respective bits, and wherein the error value is associated with a state of a written cell pair and a state of a read cell pair.

4. The method of claim 1, wherein the preconfigured condition comprises two physical error occurring between a read ternary cell pair state and a written ternary cell pair state.

5. The method of claim 1, wherein determining if the error table includes one or more errors in invalid positions comprises:
selecting each of the error values; and
determining if any of the error values include errors in a second bit and a third bit position and no error in a first bit position.

6. The method of claim 1, further comprising randomly selecting the coding tables and randomly selecting second coding tables if the error table includes one or more errors in invalid positions.

7. A method comprising:
reading a first codeword and a second codeword, the first codeword and second codeword decoded from state values of sensed ternary cells;
correcting a first bit error in the first codeword;
storing a reference to a ternary cell pair associated with the first bit error;
detecting second bit errors in the second codeword;
inverting bits associated with the second bit errors when a number of the second bit errors is equal to a predefined number of errors detectable by an error code correction (ECC) algorithm; and
correcting the second bit errors with the ECC algorithm when the number of second bit errors is less than the predefined number.

8. The method of claim 7, wherein the first codeword and second codeword are generated by:
reading states of a plurality of cell pairs;
decoding the states to generate three-bit binary values for the plurality of cell pairs;
using a first bit of each of the three-bit binary values as the first codeword; and
using a second bit and a third bit of the three-bit binary values as the second codeword.

9. The method of claim 7, wherein correcting a first bit error in the first codeword comprises correcting up to two bit errors in the first codeword using an ECC algorithm configured to correct up to two errors.

10. The method of claim 7, wherein detecting second bit errors in the second codeword comprises detecting the second bit errors with an ECC algorithm configured to detect up to four errors and correct up to three errors.

11. The method of claim 7, wherein correcting the second bit errors with an ECC algorithm comprises correcting up to three bit errors in the second codeword using an ECC algorithm configured to correct up to three errors.

12. The method of claim 7, further comprising returning a valid codeword to a device after correcting the second codeword.

13. The method of claim 12, further comprising combining the first codeword and second codeword to generate the valid codeword.

14. A method comprising:
reading a first codeword and a second codeword, the first codeword and second codeword decoded from state values of sensed ternary cells;
correcting a first bit error in the first codeword;
storing a reference to a ternary cell pair associated with the first bit error;
detecting second bit errors in the second codeword;
inverting bits associated with the second bit errors when a number of the second bit errors is within a preconfigured range of errors; and
correcting the second bit errors with an error code correction (ECC) algorithm.

15. The method of claim 14, wherein the first codeword and second codeword are generated by:
reading states of a plurality of cell pairs;
decoding the states to generate three-bit binary values for the plurality of cell pairs;
using a first bit of each of the three-bit binary values as the first codeword; and
using a second bit and a third bit of the three-bit binary values as the second codeword.

16. The method of claim 14, wherein correcting a first bit error in the first codeword comprises correcting up to two bit errors in the first codeword using an ECC algorithm configured to correct up to two errors.

17. The method of claim 14, wherein the preconfigured range of errors comprises between two to four errors.

18. The method of claim 14, wherein correcting the second bit errors with an ECC algorithm comprises correcting up to two bit errors in the second codeword using an ECC algorithm configured to correct up to two errors.

19. The method of claim 14, further comprising returning a valid codeword to a device after correcting the second codeword.

20. The method of claim 19, further comprising combining the first codeword and second codeword to generate the valid codeword.
